(19) United States
(12) Patent Application Publication
(10) Pub. No.: US 2025/0356166 A1
(43) Pub. Date: Nov. 20, 2025

(54) RECURRENCE IN TRANSFORMER ARCHITECTURE

(71) Applicant: Google LLC, Mountain View, CA (US)

(72) Inventors: Ankur P. Parikh, New York, NY (US); Jasmijn Bastings, Amsterdam (NL); Ran Tian, Astoria, NY (US); Tao Lei, Sunnyvale, CA (US)

(21) Appl. No.: 18/868,476

(22) PCT Filed: May 23, 2023
(86) PCT No.: PCT/US2023/023231

§ 371 Date: Nov. 22, 2024

Related U.S. Application Data
(60) Provisional application No. 63/344,667, filed on May 23, 2022.

(51) Int. Cl. G06N 3/045; G06F 16/31; G06N 3/044

(52) U.S. Cl. CPC G06N 3/045; G06F 16/316; G06N 3/044

(57) ABSTRACT

Methods, systems, and apparatus, including computer programs encoded on a computer storage medium, for recurrence in a transformer architecture. In one aspect, a method includes receiving input embeddings representing a sequence of words as input; generating as output attention vectors for each of the words, the attention vectors for each word indicating an importance of the word in the sequence relative to other words in the sequence; generating first and second linear transformations X̅₁ and X̅₂ of the attention vectors; determining, in a recurrent neural network, a hidden state corresponding to each attention vector using only element wise operations on the first linear transformation of the attention vectors during a recurrent step; and generating a set of output vectors using a multiplicative gating function in combination with the second linear transformation.

### CROSS-REFERENCE TO RELATED APPLICATIONS

This application claims the benefit of priority to U.S. Provisional Application No. 63/344,667 filed on May 23, 2022, the contents of which are hereby incorporated by reference.

### BACKGROUND

This specification relates to language transformer architectures.

Transformers have incorporated recurrence into their architectures. While combining attention and recurrence is useful in many cases, a combined model needs to be pre-trained and fine-tuned to achieve parity in performance of an attention-only counterpart. Moreover, it is desirable to limit the required amount of parameters and computations in a combined transformer so that they are comparable to the attention-only transformer. Moreover, achieving a recurrent model that can operate at a similar computation throughput as an attention model can be challenging. For example, requiring compute unified device architecture (CUDA) implementations for graphical processing units (GPUs) may be required to achieve such goals.

### SUMMARY

The subject matter of this written description describes a transformer that incorporates a recurrent block that replaces a feed forward block. In some implementation, the recurrent block is a SwishRNN that uses a limited number of operations in the recurrence step to accelerate computation, and that can run on both tensor processing units (TPUs) and GPUs while requiring a relatively light coding resource.

An innovative aspect of the subject matter described in this specification can be embodied transformer system, comprising: an attention layer that receives input embeddings representing a sequence of words as input and generates as output attention vectors for each of the words, the attention vectors for each word indicating an importance of the word in the sequence relative to other words in the sequence; a recurrent neural network block that: generates first and second linear transformations X̅₁ and X̅₂ of the attention vectors, and determines a hidden state corresponding to each attention vector using only element wise operations on the first linear transformation of the attention vectors during a recurrent step; and a gating block that generates a set of output vectors utilizing a multiplicative gating function in combination with the second linear transformation. Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages.

The combined attention and recurrence model can be used for language model pre-training and fine-tuning to achieve a greater accuracy than an attention-only counterpart. Additionally, the recurrent neural network (RNN) block is of lightweight design so that operations during the recurrent step are minimized. This reduces computational time and resources required for training that would otherwise be required for a more complex RNN, such as Long Short-Term Memory (LSTM) RNN.

As used herein, a lightweight RNN is an RNN that, when determining a hidden state corresponding to each attention vector, need only use element wise operations on data relating to the attention vector.

Additionally, the lightweight RNN, by using minimal operations in the recurrent step to accelerate computation, can readily be run on special processing units, such as TPUs and GPUs. For example, the lightweight RNNs described herein use a low number sequential operations and a simple sequential pooling operation.

Thus, by utilizing the lightweight RNN as described in more detail below, the model can be trained in a manner that significantly outperforms existing models that rely on attention only. The performance gain, however, is achieved with only a minimal increase in training resource requirements relative to training that would be required with a more complex RNN, such as a LSTM RNN.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example transformer architecture implementation that utilizes a recurrence block.

FIG. 2 is a block diagram of recurrence cell used in the implementation of FIG. 1.

FIG. 3 is a flow diagram of an example transformer process utilized in the example transformer architecture of FIG. 1 and the recurrence cell of FIG. 2.

Like reference numbers and designations in the various drawings indicate like elements.

### DETAILED DESCRIPTION

### Overview

In one aspect, transformer system includes an attention layer, a recurrent neural network block and a gating block. The attention layer receives input embeddings representing a sequence of words as input and generates as output attention vectors for each of the words. The attention vectors for each word indicate an importance of word the in the sequence relative to other words in the sequence. The recurrent neural network block generates first and second linear transformations X̅₁ and X̅₂ of the attention vectors, and determines a hidden state corresponding to each attention vector using only element wise operations on the first linear transformation of the attention vectors during a recurrent step. The gating block generates a set of output vectors utilizing a multiplicative gating function in combination with the second linear transformation.

In another aspect, the attention layer is a multi-head attention layer.

In another aspect, the system includes a first normalization layer between the attention layer and the recurrent neural network block, and a second normalization layer after the recurrent neural network block.

In another aspect, the attention layer, recurrent neural network block and the gating block are an encoder.

In another aspect, the recurrent neural network determines the hidden state using an element-wise Swish activation function Swish(x)=x*sigmoid(αx+β), where sigmoid(z)=(1+exp(z))⁻¹ is the sigmoid function and α and β are either constants or trainable parameters.

In another aspect, determining the hidden state corresponding to each attention vector comprises the operation of c[i]=Swish (c[i−1]−x 1[i])+x 1[i].

In another aspect, a computer implemented method comprises receiving input embeddings representing a sequence of words as input; generating as output attention vectors for each of the words, the attention vectors for each word indicating an importance of the in the sequence relative to other words in the sequence; generating first and second linear transformations X̅₁ and X̅₂ of the attention vectors; determining, in a recurrent neural network, a hidden state corresponding to each attention vector using only element wise operations on the first linear transformation of the attention vectors during a recurrent step; and generating a set of output vectors using a multiplicative gating function in combination with the second linear transformation.

In another aspect, the method further comprises the operations of normalizing the attention vectors prior to generating the first and second linear transformations.

In another aspect, determining the hidden state comprises using an element-wise Swish activation function Swish(x)=x*sigmoid(αx+β).

In another aspect, determining the hidden state corresponding to each attention vector comprises the operation of c[i]=Swish (c[i−1]−x 1[i])+x 1[i].

In another aspect, one or more non-transitory computer storage media storing instructions that when executed by one or more computers cause the one or more computers to perform operations of: receiving input embeddings representing a sequence of words as input; generating as output attention vectors for each of the words, the attention vectors for each word indicating an importance of word the in the sequence relative to other words in the sequence; generating first and second linear transformations X̅₁ and X̅₂ of the attention vectors; determining, in a recurrent neural network, a hidden state corresponding to each attention vector using only element wise operations on the first linear transformation of the attention vectors during a recurrent step; and generating a set of output vectors using a multiplicative gating function in combination with the second linear transformation.

These features and additional features are described in more detail below.

### Example Implementation

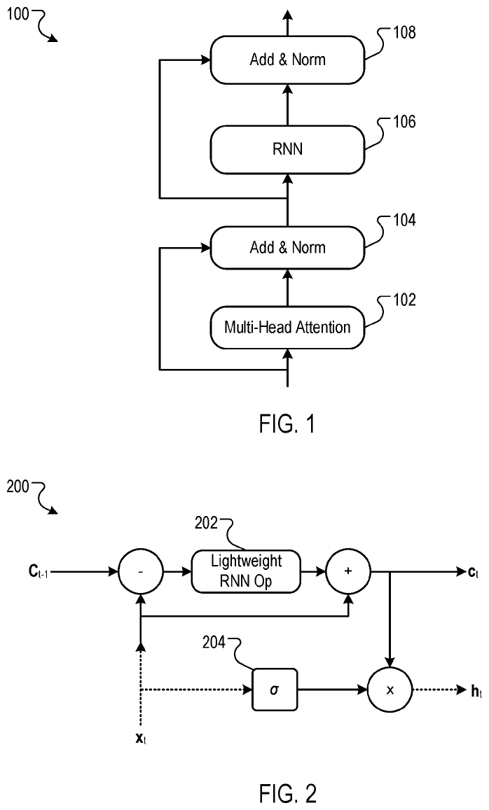

FIG. 1 is a block diagram of an example transformer architecture 100 implementation that utilizes a lightweight RNN, as indicated by the recurrence block 106. The architecture includes a multi-head attention block 102, a residual connection and layer normalization layer 104, a recurrence block 106, and another residual connection and layer normalization layer 108. The multi-head attention block 102 is configured to calculate a plurality of attention vectors from embeddings representing a sequence of words. The recurrence block 106 is configured to process input based on the plurality of attention vectors (e.g. a linear transformation of the attention vectors) to generate one or more hidden vectors using a lightweight RNN operation.

In some implementations, a transformer model includes one or more copies of the transformer the transformer architecture 100. One or more additional layers (not shown) may also be included in the transformer model, e.g. feedforward layers, convolutional layers or the like. The transformer architecture 100 can, in some examples, include multiple copies of the transformer layer (i.e. the multi-head attention block 102, the residual connection and layer normalization layer 104, the recurrence block 106, and another residual connection and layer normalization layer 108). For example, the transformer model may have 12 or 24 transformer layers.

The multi-headed attention block 102, in some implementations, includes h heads and first calculates query Qₘ, key Kₘ, and value Vₘ matrices for each head m∈{1 . . . h} by applying linear transformations, W, to the input, X:

$${Q}_{m} = {XW}_{m}^{Q} , {K}_{m} = {XW}_{m}^{K} , {V}_{m} = {XW}_{m}^{V}$$

The number of attention heads can, for example, be 12 or 16.

Attention vectors, Z, are then computed for each head, concatenated and multiplied by a linear transformation, W^{O}.

$${Z}_{m} = softmax ( \frac{{Q}_{m} {K}_{m}^{T}}{\sqrt{d}} ) {V}_{m} \\ {F}_{alt} ( X ) = Concat ( [ {Z}_{1} , … , {Z}_{h} ] ) {W}^{O}$$

The residual connection and layer normalization layers 106 and 110 apply a layer normalization to an addition of the two inputs, \tilde{X} and X, i.e., LayerNorm(\tilde{X}+X). One example of a layer normalization process is described in Ba et al., “Layer Normalization, arXiv:1607.06450. Other normalizations can also be used.

At each layer k, the hidden state of the transformer is represented by an l×d matrix X^{k}, where l is the sequence length and d is the hidden size (for simplicity of notation, the l superscript is only included below only when necessary). The intermediate hidden state X̅^{k} is thus

$${\overline{X}}^{k} := {F}_{Add + Norm} ( {F}_{alt} ( {X}^{k} ) , {X}^{k} ) \qquad ( 1 )$$

The hidden size can, for example, be between 256 and 2048, e.g. 768 or 1024.

Operation of the recurrence block 106 is described with reference to FIG. 2, which is a block diagram of a recurrence cell 200 used in the lightweight RNN recurrence block 106 of FIG. 1. Accelerator hardware devices such as TPUs and GPUs are highly optimized for matrix multiplications, which enables the efficient processing of feed-forward architectures such as attention. Recurrent networks (RNNs), however, involves sequential operations that cannot run in parallel. To achieve a training efficiency comparable to the transformer using a feed forward architecture, the systems and methods described herein use a lightweight recurrence process with reduced sequential operations.

In the implementation of FIG. 2, the RNN cell 200 uses two matrix multiplications and a sequential pooling operation. Let x̅[i]:=X̅[i, :] be the intermediate hidden vector of the i-th position from the intermediate hidden state X̅^{k} above.

The recurrence block 106 computes two linear transformation of X̅:

$${\overline{X}}_{1} = \overline{X} {W}_{1} , {\overline{X}}_{2} = \overline{X} {W}_{2} \qquad ( 2 )$$

In particular, W₁ and W₂ are d×d′ parameter matrices optimized during training (i.e. are learned linear transformations), with d is the input and output dimension of the model, and d′ is the intermediate dimension for recurrence. The hidden vectors

$${\{ c [ i ] \}}_{i = 1}^{l}$$

are calculated using a lightweight RNN operation 202, such as the Swish( ) operation:

$$c [ i ] = Swish ( c [ i - 1 ] - {\overline{x}}_{1} [ i ] ) + {\overline{x}}_{1} [ i ] \qquad ( 3 )$$

The intermediate dimension for recurrence can, for example, be between 1024 and 4096, e.g. 2048 or 2752.

The Swish( ) operation in block 202 of FIG. 2 is an element-wise activation function given by Swish(x)=x*sigmoid(αx+β). In some implementations, α is initialized to 1 and β is initialized to 0 and the scalar vectors are optimized during training. Other element-wise activation functions may alternatively be used.

An l×d′ matrix C is used to represent all concatenated version of

$${\{ c [ i ] \}}_{i = 1}^{l} ,$$

and set c[0] as an all zero vector. Note that equation (3) can be interpreted as a pooling operator where the greater value between c[i−1] and x̅[i] are selected. Note also that c[i]=x̅[i] if x̅[i]>>c[i−1], and c[i]=c[i−1] if x̅[i]<<c[i−1].

The output vector hₜ are obtained using a multiplicative gating similar to other RNNs such as LSTM, followed by a linear layer with weights W₃:

$$H = {W}_{3} ( ( C + {b}_{c} ) ⊙ σ ( {X}_{2} + {b}_{σ} ) ) + {b}_{3} \qquad ( 4 )$$

Block 204 of FIG. 2 is a gating block and is implemented by the gating activation function σ of FIG. 4. In some implementations, a GeLU activation function is used. However, other activation functions, such as a sigmoid activation function, can also be used.

Finally, for the output of the normalization layer 108 is, in some implementations, the norm of the sum of the output of the output vector H and the intermediate hidden state X̅^{k}, e.g.:

$${X}_{k + 1} = {F}_{Add + Norm} ( H , {\overline{X}}^{k} ) \qquad ( 5 )$$

In some implementations, the attention layer 102, recurrent neural network block 106 and the gating block 204 can be implemented in an encoder.

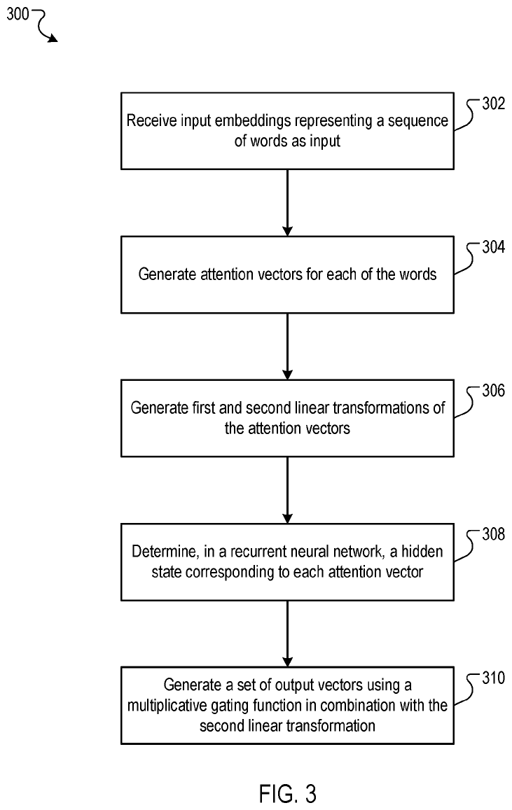

FIG. 3 is a flow diagram of an example transformer process 300 utilized in the example transformer architecture of FIG. 1 and the recurrence cell of FIG. 2. The process 300 can be implemented in hardware processors, such as general purpose processors or special purpose processors, such as GPUs and TPUs.

The process 300 receives input embeddings representing a sequence of words as input (302). For example, input embeddings derived from any appropriate corpus can be used.

The process 300 generates attention vectors for each of the words (304). In some implementations, an attention vector is generated for each of the words, and each attention vector indicates an importance of the word in the sequence relative to other words in the sequence of words.

The process 300 generates first and second linear transformations of the attention vectors (306). For example, the transformations X̅₁ and X̅₂ of the attention vectors as described with reference to equation (2) may be generated.

The process 300 determines, in a recurrent neural network, a hidden state corresponding to each attention vector (308). For example, the hidden vectors

$${\{ c [ i ] \}}_{i = 1}^{l}$$

are calculated using the RNN 106 of FIG. 1, and as described with reference to FIG. 2.

The process 300 generates a set of output vectors using a multiplicative gating function in combination with the second linear transformation (310). For example, the gating block 204 of FIG. 2 can be used, with its output fed into the multiplier operation to produce the output vectors.

In some implementations, processing speed of the process 300 can be increased by increasing a step size for the RNN 106. For example, c[i] is calculated using c[i−k] and x₁[i] with a step size of k>1. Each recurrent step can process k consecutive tokens at a time and only [l/k] steps are needed. In some implementations, the step size k∈1, 2, 4 is interleaved/alternated across recurrent layers.

In some implementations, the transformer is trained using a training method that includes a pre-training phase and a fine-tuning phase. In the pre-training phase, the transformer is with a masked language model (MLM) objective on a first set of training data (e.g. a corpus of documents, such as the Wikipedia and Book Corpus). In some implementations, the pre-training phase does not use a next sentence prediction objective, and replaces a predetermined fraction (e.g. 15%) of input tokens with the special [MASK] token. Examples of pre-training methods are described in “ROBERTa: A Robustly Optimized BERT Pretraining Approach” (Y. Liu et al., arXiv:1907.11692) and “How to Train BERT with an Academic Budget” (P. Izsak et al., In Proceedings of the 2021 Conference on Empirical Methods in Natural Language Processing, pages 10644-10652, 2021).

In the fine tuning phase, the transformer parameters are fine-tuned on one or more downstream tasks. For example, one or more datasets from the GLUE (Wang et al., 2018) and/or SuperGLUE benchmarks can be used to fine tune the transformer, e.g. the BoolQ, CoLa, MNLI, MRPC, MultiRC, QNLI, QQP, RTE, SST2 and/or STS-B datasets. In some examples, a batch size of 32 may be used for finetuning, with the Adam optimizer with a weight decay used for optimization.

### Additional Implementation Details

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A transformer system, comprising:
an attention layer that receives input embeddings representing a sequence of words as input and generates as output attention vectors for each of the words, the attention vectors for each word indicating an importance of the word in the sequence relative to other words in the sequence;
a recurrent neural network block that:
generates first and second linear transformations X̅₁ and X̅₂ of the attention vectors; and
determines a hidden state corresponding to each attention vector using only element wise operations on the first linear transformation of the attention vectors during a recurrent step; and
a gating block that generates a set of output vectors utilizing a multiplicative gating function in combination with the second linear transformation.

2. The transformer system of claim 1, wherein the attention layer is a multi-head attention layer.

3. The transformer system of claim 1, further comprising a first normalization layer between the attention layer and the recurrent neural network block, and a second normalization layer after the recurrent neural network block.

4. The transformer system of claim 3, wherein the attention layer, recurrent neural network block and the gating block are an encoder.

5. The transformer system of claim 1, wherein the recurrent neural network determines the hidden state using an element-wise Swish activation function Swish(x)=x*sigmoid(αx+β), where sigmoid(z)=(1+exp(z))⁻¹ is the sigmoid function and α and β are trainable parameters.

6. The transformer system of claim 5, wherein determining the hidden state corresponding to each attention vector comprises the operation of c[i]=Swish (c[i−1]−x ₁[i])+x ₁[i].

7. A computer implemented method, comprising:
receiving input embeddings representing a sequence of words as input;
generating as output attention vectors for each of the words, the attention vectors for each word indicating an importance of the word in the sequence relative to other words in the sequence;
generating first and second linear transformations X̅₁ and X̅₂ of the attention vectors;
determining, in a recurrent neural network, a hidden state corresponding to each attention vector using only element wise operations on the first linear transformation of the attention vectors during a recurrent step; and
generating a set of output vectors using a multiplicative gating function in combination with the second linear transformation.

8. The method of claim 7, further comprising the operations of normalizing the attention vectors prior to generating the first and second linear transformations.

9. The method of claim 7, wherein determining the hidden state comprises using an element-wise Swish activation function Swish(x)=x*sigmoid(αx+β), where sigmoid(z)=(1+exp(z))⁻¹ is the sigmoid function and α and β are trainable parameters.

10. The method of claim 9, wherein determining the hidden state corresponding to each attention vector comprises the operation of c[i]=Swish (c[i−1]−x ₁[i])+x ₁[i].

11. One or more non-transitory computer storage media storing instructions that when executed by one or more computers cause the one or more computers to perform operations of:
receiving input embeddings representing a sequence of words as input;
generating as output attention vectors for each of the words, the attention vectors for each word indicating an importance of the word in the sequence relative to other words in the sequence;
generating first and second linear transformations X̅₁ and X̅₂ of the attention vectors;
determining, in a recurrent neural network, a hidden state corresponding to each attention vector using only element wise operations on the first linear transformation of the attention vectors during a recurrent step; and
generating a set of output vectors using a multiplicative gating function in combination with the second linear transformation.

12. The non-transitory computer storage media of claim 11, the operations further comprising of normalizing the attention vectors prior to generating the first and second linear transformations.

13. The non-transitory computer storage media of claim 11, wherein determining the hidden state comprises using an element-wise Swish activation function Swish(x)=x*sigmoid(αx+β), where sigmoid(z)=(1+exp(z))⁻¹ is the sigmoid function and α and β are trainable parameters.

14. The non-transitory computer storage media of claim 12, wherein determining the hidden state corresponding to each attention vector comprises the operation of c[i]=Swish (c[i−1]−x ₁[i])+x ₁[i].
